(19) United States
(12) Patent Application Publication
(10) Pub. No.: US 2025/0066542 A1
(43) Pub. Date: Feb. 27, 2025

(54) A BIODEGRADABLE POLYMER AND A PROCESS FOR ITS PREPARATION

(71) Applicant: RELIANCE INDUSTRIES LIMITED, Mumbai (IN)

(72) Inventors: Virendrakumar GUPTA, Mumbai (IN); Sandesh Chandrakant KADAM, Mumbai (IN); Sunil DHAMANIYA, Jaipur (IN); Ashwin Kumar JAIN, Mumbai (IN); Denial MAHATA, Jhargram (IN)

(73) Assignee: RELIANCE INDUSTRIES LIMITED, Mumbai (IN)

(21) Appl. No.: 18/720,312

(22) PCT Filed: Dec. 15, 2022
(86) PCT No.: PCT/IB2022/062269

§ 371 Date: Jun. 14, 2024

(30) Foreign Application Priority Data
Dec. 16, 2021 (IN) 202121058726

(51) Int. Cl. C08G 63/672; C08G 63/78

(52) U.S. Cl. CPC C08G 63/672; C08G 63/78; C08G 2230/00

(57) ABSTRACT

The present disclosure relates to a biodegradable polymer and a process for its preparation. The components of the biodegradable polymer of the present disclosure are obtained from natural and fossil resources and therefore the biodegradable polymer of the present disclosure has enhanced biodegradation properties. The process of the present disclosure is effective.

### FIELD

The present disclosure relates to a biodegradable polymer and a process for its preparation.

### BACKGROUND

The background information herein below relates to the present disclosure but is not necessarily prior art.

Increasing plastic pollution due to the excessive disposal of non-degradable polymers have created a serious damage to the environment and human health. The non-degradable polymers consist of long chains of carbon and hydrogen atoms. These molecules form an interatomic type of bonding and is adamant i.e., it is tough for microbes to break the bonds and digest them. These polymers are polyethylene and polypropylene, which are made to be durable. Thus, a longer period is required to decompose the non-degradable polymers as they are hard to digest for microbes. Most of the non-biodegradable plastic packaging is used only once, and then it is discarded. Thus, it creates waste that is deposited on lands and in the oceans as well. affecting the natural balance of wildlife and nature.

There is, therefore, felt a need to provide a biodegradable polymer and a process for its preparation that mitigates the drawbacks mentioned hereinabove.

### OBJECTS

Some of the objects of the present disclosure, which at least one embodiment herein satisfies, are as follows:

An object of the present disclosure is to ameliorate one or more problems of the prior art or to at least provide a useful alternative.

Another object of the present disclosure is to provide a biodegradable polymer.

Still another object of the present disclosure is to provide a biodegradable polymer that has enhanced biodegradation properties, higher mechanical properties, and high melt strength.

Another object of the present disclosure is to provide a biodegradable polymer that has a comparatively broad molecular weight distribution (MWD).

Yet another object of the present disclosure is to provide a process for preparing a biodegradable polymer.

Another object of the present disclosure is to provide a simple, effective and environment friendly process for the preparation of a biodegradable polymer.

Other objects and advantages of the present disclosure will be more apparent from the following description, which is not intended to limit the scope of the present disclosure,

### SUMMARY

The present disclosure relates to a biodegradable polymer. The biodegradable polymer being a reaction product of at least one aliphatic diol in an amount in the range of 30 mass % to 40 mass % with respect to the total mass of the polymer, at least one ester of aliphatic diacid in an amount in the range of 10 mass % to 35 mass % with respect to the total mass of the polymer, one of compound selected from tartrate and threitol in an amount in the range of 5 massi to 25 mass % with respect to the total mass of the polymer, at least one catalyst in an amount in the range of 0.5 mass % to 1.5 mass % with respect to the total mass of the polymer and at least one ester of aromatic diacid in an amount in the range of 25 mass % to 35 mass % with respect to the total mass of the polymer.

The present disclosure also relates to a process for preparing a biodegradable polymer. The process comprises the step of passing an inert atmosphere in a reactor. Predetermined amounts of at least one aliphatic diol, at least one ester of aliphatic diacid, one of compound selected from tartrate and threitol, at least one catalyst and optionally at least one branching agent are mixed under the inert atmosphere in the reactor to obtain a slurry. The slurry is heated at a first predetermined temperature for a first predetermined time period followed by addition of a predetermined amount of at least one ester of aromatic diacid to obtain a homogeneous mixture. The homogeneous mixture is heated at a second predetermined temperature for a second predetermined time period at a predetermined pressure in the inert atmosphere to obtain the biodegradable polymer.

The biodegradable polymer of the present disclosure is characterized by having number average molecular weight (Mn) in the range of 5×10³ g/mol to 50×10³ g/mol, weight average molecular weight (Mw) in the range of 10×10³ g/mol to 120×10³ g/mol. polydispersity index (PDI) in the range of 1 to 3, melting temperature (Tm) in the range of 70° C. to 140° C., glass transition temperature (Tg) in the range of −50° C. to −20° C., crystallization temperature (Te) in the range of 65° C. to 115° C., and enthalpy of the reaction (AH) in the range of 3 J/g to 8 J/g.

### BRIEF DESCRIPTION OF THE ACCOMPANYING DRAWING

The present disclosure will now be described with the help of the accompanying drawing, in which:

FIG. 1 illustrates a proton nuclear magnetic resonance (¹H NMR) of the biodegradable polyester P₁ in accordance with the present disclosure:

FIG. 2 illustrates a carbon-nuclear magnetic resonance (¹³C NMR) of the biodegradable polyester P₁ in accordance with the present disclosure;

FIG. 3 illustrates a proton-nuclear magnetic resonance (¹H NMR) of the biodegradable polyester P₂ in accordance with the present disclosure;

FIG. 4 illustrates a carbon-nuclear magnetic resonance (¹³C NMR) of the biodegradable polyester P₂ in accordance with the present disclosure;

FIG. 5 illustrates a proton-nuclear magnetic resonance (¹H NMR) of the biodegradable polyester P₃ in accordance with the present disclosure;

FIG. 6 illustrates a carbon-nuclear magnetic resonance (¹³C NMR) of the biodegradable polyester P₃ in accordance with the present disclosure;

FIG. 7 illustrates a proton-nuclear magnetic resonance (¹H NMR) of the biodegradable polyester P₅ (Comparative Experiment 2);

FIG. 8 illustrates a carbon-nuclear magnetic resonance (¹³C NMR) of the biodegradable polyester P₅ in accordance with the present disclosure (Comparative Experiment 2);

FIG. 9 illustrates a BOD (mg/Kg) of the polyester polymer P₁ in accordance with the present disclosure;

FIG. 10 illustrates a BOD (mg/Kg) of polyester polymer P₄ (Comparative Experiment 1); and

FIG. 11 illustrates a BOD (mg/Kg) of the polyester polymer P₅ (Comparative Experiment 2).

### DETAILED DESCRIPTION

Embodiments of the present disclosure will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well. unless the context clearly suggests otherwise. The terms “comprises.” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

Increasing plastic pollution due to the excessive disposal of non-degradable polymers have created a serious damage to the environment and human health. The non-degradable polymers consist of long chains of carbon and hydrogen atoms. These molecules form an interatomic type of bonding and is adamant i.e., it is tough for microbes to break the bonds and digest them. These polymers are polyethylene and polypropylene, which are made to be durable. Thus a long period is required to decompose the non-degradable polymers, as they are hard to digest for microbes. Most of the non-biodegradable plastic packaging is used only once, and then it is discarded. Thus, it creates waste that is deposited on lands and in the oceans as well, affecting the natural balance of wildlife and nature,

The present disclosure relates to a biodegradable polymer and a process for its preparation.

In an aspect, the present disclosure provides a biodegradable polymer. The biodegradable polymer being a reaction product of at least one aliphatic diol in an amount in the range of 30 mass % to 40 massi % with respect to the total mass of the polymer, at least one ester of aliphatic diacid in an amount in the range of 10 mass % to 35 mass % with respect to the total mass of the polymer, one of compound selected from tartrate and threitol in an amount in the range of 5 masse to 25 mass % with respect to the total mass of the polymer, at least one catalyst in an amount in the range of 0.5 mass % to 1.5 masse with respect to the total weight of the polymer and at least one ester of aromatic diacid in an amount in the range of 25 mass % to 35 mass % with respect to the total mass of the polymer.

In accordance with the present disclosure, the biodegradable polymer comprises at least one branching agent in an amount in the range of 0 mass % to 0.2 mass % with respect to the total mass of the polymer.

In accordance with an embodiment of the present disclosure, the branching agent is at least one selected from the group consisting of mucic acid, glycerol, pentaerythritol, 1.1,1-trimethylolethane, 1.2.4-butanetriol, trimellitic acid, pyromellitic acid, trimethylolethane, polyethertriol, trimesic acid, pyromellitic acid and hydroxyisophthalic acid. In an exemplary embodiment, the branching agent is mucic acid.

In accordance with an embodiment of the present disclosure, the aliphatic diol is at least one selected from the group consisting of ethylene glycol. 1.2-propanediol, 1,3-propanediol. 1.2-butanediol, 1,4-butanediol, 1,5-pentanediol, 1,6-hexanediol, 2,4-dimethyl-2-ethyl-1,3-hexanediol, 2,2-dimethyl-1.3- propanediol, 2-ethyl-2-butyl-1,3-propanediol, 2-ethyl-2-isobutyl-1,3-propanediol and 2.2.4-trimethyl-1,6-hexanediol, 1,2-cyclopentanediol, 1,2-cyclohexanediol, 1,4-cyclohexanediol, 1,2-cyclohexanedimethanol, 1,3 cyclohexanedimethanol, 1,4-cyclohexanedimethanol and derivatives thereof. In an exemplary embodiment, the aliphatic diol is 1,4-butanediol.

In accordance with an embodiment of the present disclosure, the aliphatic diacid is at least one selected from the group consisting of oxalic acid, malonic acid. succinic acid, glutaric acid, adipie acid, pimelic acid, suberic acid, azclaic acid, sebacic acid, ondecanedioic acid, dodecanedioic acid, brassylic acid, tetradecanedioic acid. 1,3-cyclopentanedicarboxylic acid, 1,4-cyclohexanedicarboxylic acid, 1,3 cyclohexanedicarboxylic acid, diglycolic acid, itaconic acid, maleic acid, fumaric acid, maleic anhydride and derivatives thereof. In an exemplary embodiment, the aliphatic diacid is adipie acid.

In accordance with an embodiment of the present disclosure, the ester of aliphatic diacid is selected from the group consisting of dimethyl adipate, dimethyl succinate, dimethyl malonate, dimethyl glutarate, dimethyl suberate, and dimethyl sebacate, In an exemplary embodiment. the ester of aliphatic diacid is dimethyl adipate.

In accordance with an embodiment of the present disclosure, the tartrate is dimethyl 2,3-O-isopropylidene tartrate, and the threitol is 2,3- [symbol] -isopropylidene threitol.

In accordance with an embodiment of the present disclosure, the catalyst is at least one selected from the group consisting of titanium, tetrabutyl titanate, tetrapropyl titanate, calcium acetate, antimony trioxide, monobutyl tin oxide, zinc acetate, and antimony acetate. In an exemplary embodiment, the catalyst is titanium catalyst.

In accordance with an embodiment of the present disclosure, the aromatic diacid is at least one selected from the group consisting of terephthalic acid. phthalic acid, isophthalic acid. 4-methylphthalic acid, naphthalene dicarboxylic acid, and derivatives thereof. In an exemplary embodiment, the aromatic diacid is dimethyl terephthalate.

In accordance with an embodiment of the present disclosure, the ester of the aromatic diacid is selected from dimethyl terephthalate, phthalic anhydride. dimethyl isophthalate. 4-methylphthalic anhydride, and dimethyl phthalate. In an exemplary embodiment, the ester of the aromatic diacid is dimethyl terephthalate.

In accordance with an embodiment of the present disclosure, the biodegradable polymer being a reaction product of 1,4-Butanediol in an amount of 36 mass % with respect to the total mass of the polymer, dimethyl adipate in an amount of 15mass % with respect to the total mass of the polymer, dimethyl 2,3- [symbol] -isopropylidene tartrate in an amount of 20 mass % with respect to the total mass of the polymer, titanium catalyst in an amount of 1 masse % with respect to the total mass of the polymer, dimethyl terephthalate in an amount of 28 mass % with respect to the total mass of the polymer.

The biodegradable polymer of the present disclosure has enhanced biodegradation properties, higher mechanical properties, and high melt strength.

The biodegradable polymer of the present disclosure has a comparatively broad molecular weight distribution (MWD).

The biodegradable polymer of the present disclosure is characterized by having:
number average molecular weight (Mn) in the range of 5×10³ g/mol to 50×10³ g/mol;
weight average molecular weight (Mw) in the range of 10×10³ g/mol to 120 10³ g/mol;
polydispersity index (PDI) in the range of 1 to 3;
melting temperature (Tm) in the range of 70° C. to 140° C.;
glass transition temperature (Tg) in the range of −50° C. to −20° C.;

· crystallization temperature (Tc) in the range of 65° C. to 115° C.; and
enthalpy of the reaction (ΔH) in the range of 3 J/g to 8 J/g.

In another aspect, the present disclosure relates to a process for preparing a biodegradable polymer.

Initially, an inert atmosphere (gas) is passed in a reactor.

In accordance with an embodiment of the present disclosure, the inert atmosphere (gas) is selected from nitrogen and argon.

Predetermined amounts of at least one aliphatic dio,. at least one ester of aliphatic diacid, one of compound selected from tartrate and threitol, at least one catalyst and optionally at least one branching agent are mixed under the inert atmosphere in the reactor to obtain a slurry.

In accordance with an embodiment of the present disclosure, the aliphatic diol is at least one selected from the group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethyl-1,3-hexanediol, 2.2-dimethyl-1,3-propanediol, 2-ethyl-2-butyl-1,3-propanediol, 2-ethyl-2-isobutyl-1,3-propanediol and 2.2.4-trimethyl-1,6-hexanediol. 1.2-cyclopentanediol, 1,2-cyclohexanediol, 1,4-cyclohexanediol, 1,2-cyclohexanedimethanol, 1,3-cyclohexanedimethanol, 1,4-cyclohexanedimethanol and derivatives thereof. In an exemplary embodiment, the aliphatic diol is 1,4-butanediol.

In accordance with an embodiment of the present disclosure, the aliphatic diacid is at least one selected from the group consisting of oxalic acid, malonic acid, succinic acid, glotaric acid, adipic acid, pimelic acid, suberic acid, azelaic acid, sebacic acid, undecanedioic acid, dodecanedioic acid, brassylic acid, tetradecanedioic acid. 1,3-cyclopentanedicarboxylic acid. 1,4-cyclohexanedicarboxylic acid, 1,3-cyclohexanedicarboxylic acid, diglycolic acid, itaconic acid, maleic acid, fumaric acid, maleic anhydride and derivatives thereof. In an exemplary embodiment, the aliphatic diacid is adipic acid.

The ester of the aliphatic diacid is at least one selected from the group consisting of dimethyl adipate, dimethyl succinate, dimethyl malonate, dimethyl glutarate, dimethyl soberate, and dimethyl sebacate. In an exemplary embodiment, the ester is dimethyl adipate.

In accordance with an embodiment of the present disclosure, the tartrate is dimethyl 2,3- [symbol] -isopropylidene tartrate, and the threitol is 2,3- [symbol] -isopropylidene threitol.

Tartaric acid is a naturally occurring compound of functional diacids and widely produced as the byproduct in the wine industries. Particularly, for the tartaric acid, the derivatives of the same are prepared in such a way that free hydroxyl groups are protected with a protective group. The functional diacids are naturally occurring sugar based compounds and its derivatives. The derivatives of the functional diacids are provided herein below structures.

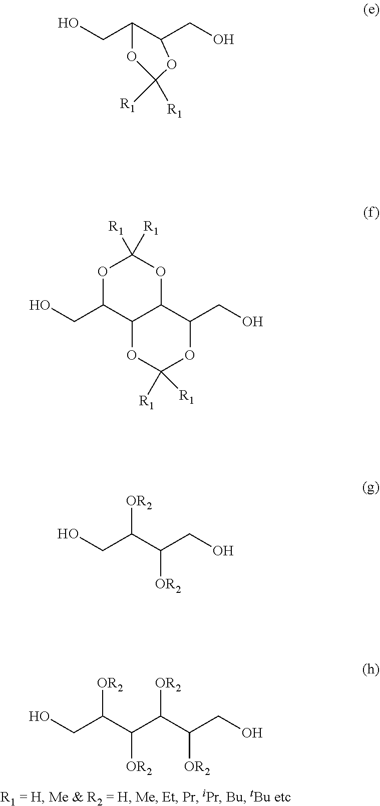

The derivatives of the functional diols are provided herein below structures.

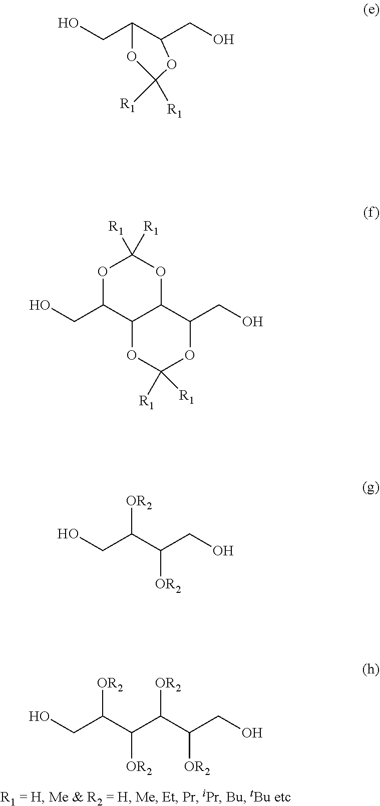

The protection methodology is used to adopt in tartaric acid, so that a linear polyester can be prepared, otherwise, such polymerization end-up in the gelation, due to excessive crosslinking. These side functional (hydroxyl) groups present in the tartaric acid can be achieved through post polymerization modification by deprotection methodology. These functional (hydroxyl) groups present in the tartaric acid have various sites to undergo the polycondensation reaction. Therefore, the secondary hydroxyl groups have been protected, due to which the gel formation is avoided that may arise due to excessive crosslinking. The advantage of the use of the tartatic acid is that it has additional polar moieties as side/pendant groups that could enhance the biodegradability of the synthesized polymers. Similarly, due to presence of side/pendant groups at the end of the polymer, the polymer has high amorphous content that eventually contribute to enhanced biodegradability.

The functional monomers as shown in above structures are naturally occurring sugar based diacid and diol derivatives. These functional monomers have various sites to undergo the polycondensation reaction, therefore, the secondary hydroxyl groups have been protected, which avoids the gel formation that may arise due to excessive crosslinking. The advantage of these kind of functional monomers are that they have additional polar moieties as side/pendant groups that could enhance the biodegradability of the synthesized polymers. Similarly, due to the presence of side/pendant groups at the end of the polymer, the polymer would consist of high amorphous content that eventually contribute to enhanced biodegradability. Furthermore, the polymerization process of the present disclosure then produces a polyester with broad MWD. The polycondensation process parameters with different amount of branching agents can offer a polymer that holds varying degree of MWD. These polymers with broad MWD have suitability for foaming application. The MWD can be measured by polydispersity index (PDI) of the polymer. A wide range of PDI (in the range of 1 to 3) has been obtained by process optimization and by employing a varying amount of the branching agent. A high branched polymer bas better mechanical properties and melt strength as compared to the non-branched polymer. For example, for a foaming applications, a high melt strength polymer is desirable. The present process enables to offer polymers with improved biodegradability where molecular weight distribution (MWD) can be optimized and a desired MWD can be achieved as per the target application.

In accordance with an embodiment of the present disclosure, the catalyst is at least one selected from the group consisting of titanium, tetrabutyl titanate, tetrapropyl titanate, calcium acetate, antimony trioxide, monobutyl tin oxide, zinc acetate, and antimony acetate. In an exemplary embodiment, the catalyst is titanium catalyst.

In accordance with an embodiment of the present disclosure, the branching agent is at least one selected from the group consisting of mucic acid, glycerol, pentaerythritol, 1,1,1-trimethylolethane, 1,2,4-butanetriol, trimellitic acid, pyromellitic acid, trimethylolethane, polyethertriols, trimesic acid, pyromellitic acid and hydroxyisophthalic acid. In an exemplary embodiment, the branching agent is mucic acid.

Furthermore, the present disclosure relates to the polymerization process than can produce a polyester with a comparatively broad MWD.

The percent biodegradation of tartrate modified polymer of the present disclosure is 91 mass %. Therefore, it is concluded that incorporation of tartrate in the polymer enhances the biodegradation properties of the polymer.

In accordance with an embodiment of the present disclosure, the mass ratio of the aliphatic diol to the aromatic diol is in the range of 1:0.5 to 1:2. In an exemplary embodiment, the mass ratio of to the aliphatic diol and to the aromatic diol is 1:0.9. In another exemplary embodiment, the mass ratio of the aliphatic diol to the aromatic diol is 1:1.8.

The sources of 1,4-Butanediol, dimethyl adipate, dimethyl 2,3- [symbol] -isopropylidene tartrate, and dimethyl terephthalate are fossil oil and renewable sources.

In accordance with the present disclosure, the polycondensation process parameters with different amount of branching agents offer a polymer that holds varying degree of MWD. These polymers with broad MWD have suitability for the foaming application. The MWD can be measured by polydispersity index (PDI) of the polymer. A wide range of PDI i.e. 1 to 3 has been obtained by the process optimization and by employing the varying amount of mucic acid. A high branched polymer has better melt strength as compared to the non-branched polymer. For foaming applications, a high melt strength polymer is desirable.

The slurry is heated at a first predetermined temperature for a first predetermined time period followed by the addition of a predetermined amount of at least one ester of aromatic diacid to obtain a homogeneous mixture.

In accordance with an embodiment of the present disclosure, the aromatic diacid is at least one selected from the group consisting of terephthalic acid, phthalic acid, isophthalic acid, 4-methylphthalic acid, naphthalene dicarboxylic acid, and derivatives thereof.

In accordance with an embodiment of the present disclosure, the ester of the aromatic diacid is selected from dimethyl terephthalate, phthalic anhydride, dimethyl isophthalate, 4-methylphthalic anhydride, and dimethyl phthalate. In an exemplary embodiment. the ester of the aromatic diacid is dimethyl terephthalate.

In accordance with an embodiment of the present disclosure, the first predetermined temperature is in the range of 160° C. to 180° C. and the first predetermined time period is in the range of 2 hours to 4 hours. In an exemplary embodiment, the first predetermined temperature is 170° C. and the first predetermined time period is 3 hours.

The homogeneous mixture is heated at a second predetermined temperature for a second predetermined time period at a predetermined pressure in the inert atmosphere to obtain the biodegradable polymer.

The esterification takes place by a condensation polymerization process and polycondensation process. The polycondensation process operates at high temperature in the range of 230° C. to 300° C. and under high vacuum in the range of 10 torr to 0.1 torr. The time period for the both processes (condensation polymerization and polycondensation) can be determined through the measurement of by-product that is collected during the process. The variation of the polycondensation process parameters with different amount of the branching agents can offer a polymer that holds a varying degree of molecular weight distribution (MWD). These polymers with broad MWD have suitability for the foaming application. A high branched polymer has better melt strength as compared to the non-branched polymer. For foaming applications, the high melt strength polymer is desirable.

In accordance with an embodiment of the present disclosure, the second predetermined temperature is in the range of 190° C. to 250° C. and the second predetermined time period is in the range of 4 hours to 6 hours. In an exemplary embodiment, the second predetermined temperature is 230° C. and the second predetermined time period is 5 hours.

In accordance with an embodiment of the present disclosure, the predetermined pressure is in the range of 1 torr to 5 torr. In an exemplary embodiment, the predetermined pressure is 3 torr.

The biodegradable polymer prepared in accordance with the present disclosure is used for different downstream processes such as cast extrusion film, blown extrusion films, foams and fibers preparation.

The foregoing description of the embodiments has been provided for purposes of illustration and is not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTAL DETAILS

### Experiment 1: Preparation of a Biodegradable Polyester Polymer P₁ in Accordance with the Present Disclosure

29 g of 1,4 butanediol, 12.33 g of dimethyl adipate. 15.44 g of dimethyl 2,3- [symbol] -isopropylidene tartrate and 0.9 g of titanium catalyst were mixed in 500 ml three necked round bottom flask fitted with overhead stirrer under a nitrogen atmosphere to obtain a slurry. The slurry was heated at 170° C. for 3 hours followed by addition of 22.5 g of dimethyl terephthalate to obtain a reaction mixture. The reaction mixture was further heated for 3 hrs till the formation of by-product ceased. Further, a vacuum of 3 torr was applied to the reaction mixture and further heated with gradual increasing the temperature at 230° C. for 5 hours to obtain the biodegradable polyester polymer P₁.

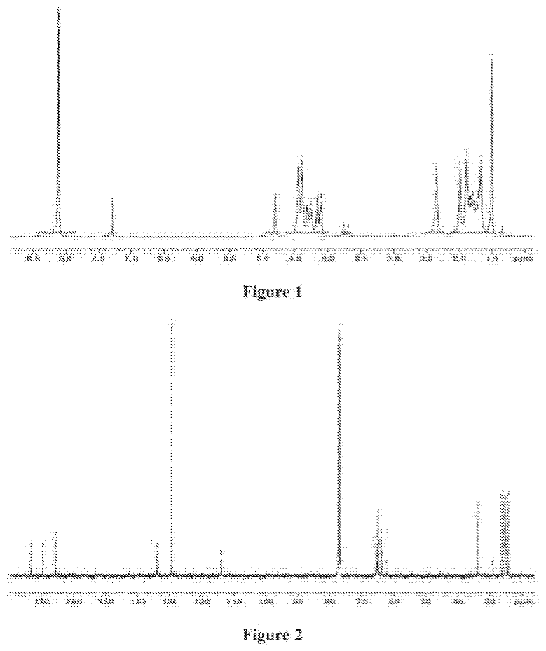

FIG. 1 illustrates a hydrogen-nuclear magnetic resonance (¹H NMR) of the biodegradable polyester P₁ and FIG. 2 illustrates a carbon-nuclear magnetic resonance (¹³NMR) of the biodegradable polyester P₁.

FIGS. 1 and 2 represent the proton and carbon NMR, respectively to define the chemical structure of the synthesized polymer P₁.

### Experiment 2: Preparation of a Biodegradable Polyester Polymer P₂ in Accordance with the Present Disclosure

26.23 g of 1,4 butanediol. 24.7 g of dimethyl adipate, 5 g of 2,3- [symbol] -isopropylidene threitol, and 0.9 g of titanium catalyst were mixed in 500 ml three necked round bottom flask fitted with overhead stirrer under the nitrogen atmosphere to obtain a slurry. The slurry was heated at 170° C. for 3 hours followed by addition of 22.5 g of dimethyl terephthalate to obtain a reaction mixture. The reaction mixture was further heated for 3 hrs till the formation of by-product ceased. Further, a vacuum of 3 torr was applied to the reaction mixture and further heated with gradual increasing the temperature at 230° C. for 5 hours to obtain the biodegradable polyester polymer P₂.

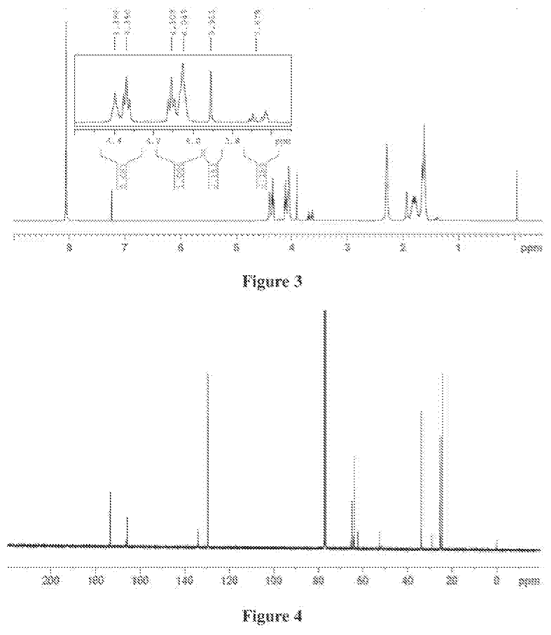

FIG. 3 illustrates a proton-nuclear magnetic resonance (¹H NMR) of the biodegradable polyester P₂ in accordance with the present disclosure;

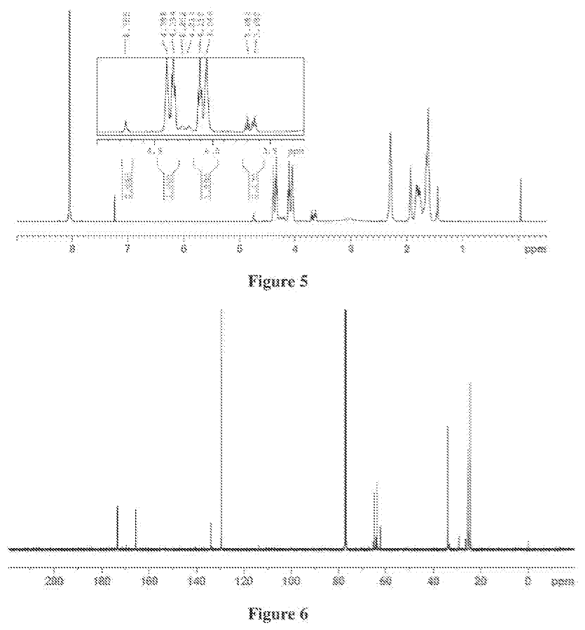

FIG. 4 illustrates a carbon-nuclear magnetic resonance (¹³C NMR) of the biodegradable polyester P₂ in accordance with the present disclosure;

FIGS. 3 and 4 represent the Proton and Carbon NMR, respectively to define the chemical structure of synthesized polymer P2

### Experiment 3: Preparation of a Biodegradable Polyester Polymer P3 in Accordance with the Present Disclosure

29 g of 1,4 butanediol, 22.2 g of dimethyl adipate. 3.1 g of dimethyl 2,3- [symbol] -isopropylidene tartrate, 0.108 g of mucic acid and 0.9 g of titanium catalyst were mixed in 500 ml three necked round bottom flask fitted with overhead stirrer under the nitrogen atmosphere to obtain a slurry. The slurry was heated at 170° C. for 3 hours followed by addition of 22.5 g of dimethyl terephthalate to obtain a reaction mixture. The reaction mixture was further heated for 3 hrs till the formation of by-product ceased. Further, a vacuum of 3 torr was applied to the reaction mixture and further heated with gradual increasing the temperature at 230° C. for 5 hours to obtain the biodegradable polyester polymer P₃.

FIG. 5 illustrates a proton-nuclear magnetic resonance (¹H NMR) of the biodegradable polyester P₃ in accordance with the present disclosure;

FIG. 6 illustrates a carbon-nuclear magnetic resonance (¹³C NMR) of the biodegradable polyester P₃ in accordance with the present disclosure;

FIGS. 5 and 6 represent the proton and carbon NMR, respectively to define the chemical structure of synthesized polymer P₃.

### Comparative Experiment 1: Preparation of a Biodegradable Polyester Polymer P₄

17,900 g of terephthalic acid, 19,200 g of adipic acid, 39,000 g of 1,4 butanediol and 70 g of titanium catalyst were mixed under the nitrogen atmosphere to obtain a slurry. The slurry was pre-dried and esterified in the nitrogen atmosphere under stirring to obtain a homogeneous mixture, 100 ppm of sodium carbonate. 100 ppm of phosphoric acid were mixed with the homogeneous mixture to obtain a reaction mixture. The reaction mixture was heated at 210° C. for 3 hour to obtain an oligomer. The oligomer was transferred to a polycondensation reactor. The oligomer was condensed at 250 to 260° C. for 3 hours under vacuum at 200 torr to 1 torr for 2 hours, and then less than 1 torr for 1 hour to obtain the biodegradable polyester polymer P₄. The by-product formed in the condensation reaction was removed by distillation.

### Comparative Experiment 2: Preparation of a Biodegradable Polyester Polymer P₅

51 g of 1,4 butanediol. 44.85 g of dimethyl adipate, and 1.8 g of titanium catalyst were mixed in 500 ml three necked round bottom flask fitted with overhead stirrer under the nitrogen atmosphere to obtain a slurry, The slurry was heated at 170° C. for 3 hours followed by addition of 50 g of dimethyl terephthalate to obtain a reaction mixture. The reaction mixture was further heated for 3 hrs till the formation of by-product ceased. Further, a vacuum of 3 torr was applied to the reaction mixture and further heated with gradual increasing the temperature at 200° C. for 5 hours to obtain the biodegradable polyester polymer P₅.

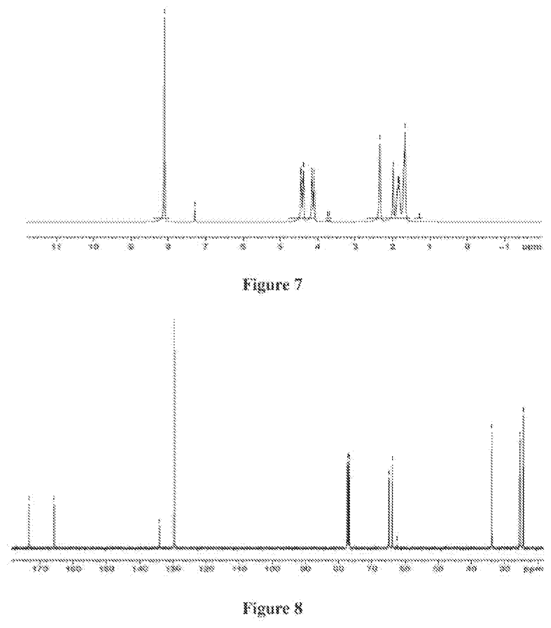

FIG. 7 illustrates a proton-nuclear magnetic resonance (¹H-NMR) of the biodegradable polyester P₅ (Comparative Experiment 2) and FIG. 8 illustrates a carbon-nuclear magnetic resonance (¹³NMR) of the biodegradable polyester P₅ (Comparative Experiment 2)

FIGS. 7 and 8 represent the Proton and Carbon NMR, respectively to define the chemical structure of synthesized polymers P5.

The characteristics of the biodegradable polyester polymers P₁, P₂, P₃, P₄, and P₅ are provided herein below Table 1.

TABLE 1
Characteristics of the biodegradable polyester polymer and P₁, P₂, P₃, P₄, and P₅

| Sr. | | Value | | | | | | | | | |
|---|---|---|---|---|---|---|---|---|---|---|---|
| No. | Characteristic | P₁ | | P₂ | | P₃ | | P₄_{(comparative Example)} | | P₅_{(comparative Example)} | |
| 1 | Number average | 10.1 × 10³ | g/mol | 7 × 10³ | g/mol | 10.8 × 10³ | g/mol | 39.3 × 10³ | g/mol | 19.2 × 10³ | g/mol |
| | molecular weight | | | | | | | | | | |
| | (Mn)* | | | | | | | | | | |
| 2 | Weight average | 19 × 10³ | g/mol | 14.2 × 10³ | g/mol | 23.5 × 10³ | g/mol | 93 × 10³ | g/mol | 41.1 × 10³ | g/mol |
| | molecular weight | | | | | | | | | | |
| | (Mw)* | | | | | | | | | | |
| 3 | Polydispersity | 1.9 | | 2.0 | | 2.3 | | 2.4 | | 2.1 | |
| | index (PDI)* | | | | | | | | | | |
| 4 | Melting | 134.5° | C. | 76.4° | C. | 119.3° | C. | 119.5° | C. | 135.9° | C. |
| | temperature (Tm)** | | | | | | | | | | |
| 5 | Glass transition | −22.7° | C. | −47° | C. | −43.4° | C. | −31.9° | C. | −30.1° | C. |
| | temperature (Tg)** | | | | | | | | | | |
| 6 | Crystallization | 105.1° | C. | 72.7° | C. | 110.7° | C. | 72.9° | C. | 98.8° | C. |
| | temperature (Tc) | | | | | | | | | | |
| 2 | Enthalpy of the | 5.8 | J/g | 3.4 | J/g | 6.9 | J/g | 12.4 | J/g | 13 | J/g |

reaction (ΔH)

*Molecular weight (Mn and Mw) were measured by using gel permeation chromatography (GPC) technique. GPC measurements were carried on a Thermo Quest (TQ) GPC at 25° C. using Chloroform (Merck, Lichrosolv) as the mobile phase. The analysis was carried out at a flow rate 1 mL/min using a set of three PL-gel (10 u) Mixed-B column with a linear molecular weight operating range of 500-10,000,000 g/mol (PS equivalent) along with a guard column and a Refractive Index (RDI) detector. Columns were calibrated with polystyrene standards and the molecular weights reported are with respect to polystyrene.
**Thermal transition behaviors were recorded on a TA (Q2000, Germany) differential scanning calorimeter (DSC) for a temperature in the range of −100° C. to +250° C. at a scanning rate of 10° C./min under a nitrogen atmosphere. Analysis of all the sample were carried out after drying under the vacuum oven to remove the moisture.

### Experiment 4: Biodegradation Studies of the Polyester Polymers, in Accordance with the Present Disclosure

The biodegradation studies of the polyester polymer samples were carried out through IS/ISO 14851—‘Determination of the ultimate aerobic biodegradability of plastic materials in an aqueous medium method by measuring the oxygen demand in a closed respirometer.

The ultimate aerobic biodegradation stands for the breakdown of an organic compound by microorganisms in the presence of oxygen into carbon dioxide, water and mineral salts of any other elements present (mineralization) plus new biomass.

The biodegradability of plastic material was determined by using the aerobic microbes in the aqueous system. Sample (polyester polymer) along with inoculum was placed in a closed respirometer. Activated sludge was used as the inoculum. The reference material used here was microcrystalline cellulose. The duration of the study was 6 months or the time taken for 90% degradation of plastic material, whichever is less. The incubation temperature condition was 20° C. to 25° C.

(1) Biochemical oxygen demand (BOD)

The mass concentration of the dissolved oxygen consumed under specified conditions by the aerobic biological oxidation of a chemical compound or organic matter in water, expressed as milligrams of oxygen uptake per milligram or gram or Kg of the samples (polyester polymers).

(ii) Theoretical oxygen demand (ThOD)

The theoretical maximum amount of oxygen required to oxidize a chemical compound completely, calculated from the molecular formula, expressed as milligrams of oxygen uptake per milligram or gram or Kg of the samples (polyester polymers).

The percentage biodegradation (% BD) can be calculated as the ratio of biochemical oxygen demand and the theoretical oxygen demand.

$$percentage biodegradation ( \% BD ) = ( BOD / ThOD ) \times 100$$

The biodegradation results (Table 2) of samples P₁, P₄, and P₅ in 70 days had been resulted into the theoretical oxygen demand (ThOD) of 1370511 mg/kg, 2630193 mg/kg, and 1960000 mg/kg, respectively, The biochemical oxygen demand (BOD) of samples P₁, P₄, and P₅ were found 1250000 mg/kg, 580000 mg/kg, and 480000 mg/kg. respectively.

TABLE 2
Biodegradation results of prepared polyester
polymers P1, P₄, P₅ are shown after 70 days

| | Theoretical | Biological | Biodegradation (%); |
|---|---|---|---|
| | oxygen demand | oxygen demand | (% BD) = (BOD/ |
| Samples | (ThOD) (mg/kg) | (BOD) (mg/kg) | ThOD) × 100 |
| P₁ | 1370511 | 1250000 | 91 |
| P₄ | 2630193 | 580000 | 22 |
| P₅ | 1960000 | 480000 | 25 |

From Table 2, it is evident that the percent of biodegradation of polymers P₄ and P₅ had been observed approximately 22 wt % and 25 wtf %. However, the percent of biodegradation of tartrate modified polymer P₁ was obtained 91 wt %.

Therefore, it is concluded that incorporation of tartrate enhances the biodegradation properties in polyester.

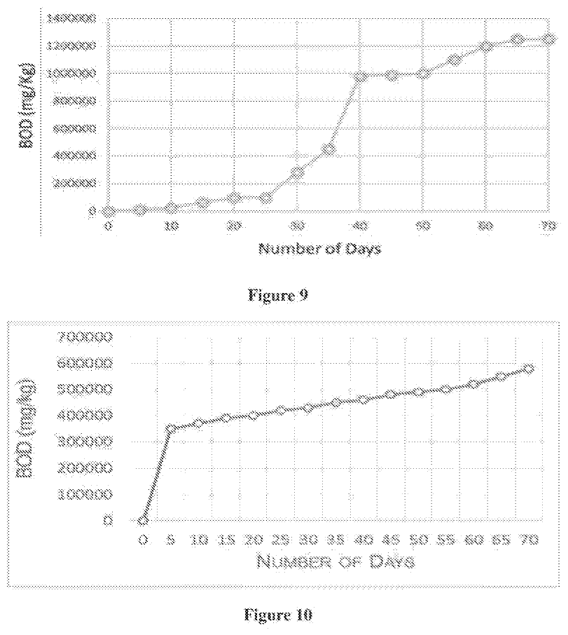

FIG. 9 illustrates a BOD (mg/Kg) of the polyester polymer P₁ in accordance with the present disclosure

FIG. 10 illustrates a BOD (mg/Kg) of polyester polymer P₄ (Comparative experiment 1); and

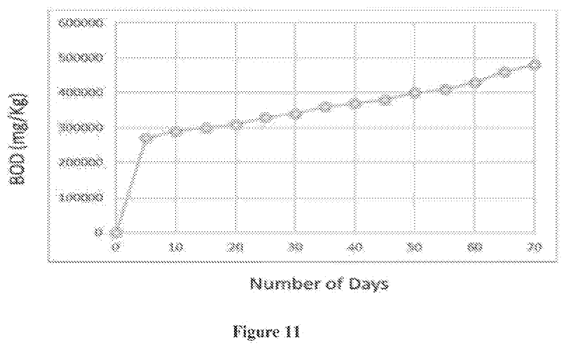

FIG. 11 illustrates a BOD (mg/Kg) of the polyester polymer P₅ (Comparative experiment 2).

FIG. 9, FIG. 10, and FIG. 11 represents biodegradation of polymers P, P4 and P5 respectively.

### Experiment 5: Solution Blending of Polyester P₁ with Other Polymers:

Biodegradable blends can be made with the polyesters of the present disclosure by using organic and inorganic fillers useful in downstream process like melt extrusion and film preparation.

10 g of the polyester P₁ was taken for blending with 20 wt % of Polylactic acid (PLA) (Mₙ7.8×10⁴; PDI=2.2) and solution blending was carried out using chloroform or Tetrahydrofuran (THF) as a solvent at ambient temperature. The films of the same were prepared and mechanical properties were measured by ASTM D882.

The mechanical properties of the solution blended polyester P₁ are observed as tensile strength at break 6.5 MPa, tensile stress at yield 8.0 MPa and elongation at break 122%.

### Experiment 6: Cast Extrusion Film and Mechanical Properties of the Polyester Polymer P₄

A cast film of polymer P₄ was prepared by the hot press two-roll mill within a temperature range of 110° C. to 125° C. Test specimens were cut from the cast film and measured the tensile properties by following ASTM b 882.

The mechanical properties of the cast extrusion film are observed as tensile strength at break 29 MPa, tensile stress at yield 7.0 MPa and elongation at break 1128%.

### TECHNICAL ADVANCEMENTS AND ECONOMIC SIGNIFICANCE

The present disclosure described herein above has several technical advantages including, but not limited to, the realization of a biodegradable polymer that:
has enhanced biodegradation properties;
has improved the amorphous properties for better transmission of moisture in polymer bulk to facilitate polymer chain cleavage;
avoids gel formation that may arise due to excessive crosslinking; and p1 molecular weight distribution (MWD) can be optimized through the use of the branching agents for target applications.

Throughout this specification the word “comprise”, or variations such as “comprises” or “comprising, will be understood to imply the inclusion of a stated element, integer or step,” or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

One of the objects of the Patent Law is to provide protection to new technologies in all fields and domain of technologies. The new technologies shall or may contribute in the country economy growth by way of involvement of new efficient and quality method or product manufacturing in India.

To provide the protection of new technologies by patenting the product or process will contribute significant for innovation development in the country. Further by granting patent the patentee can contribute in manufacturing the new product or new process of manufacturing by himself or by technology collaboration or through the licensing.

The applicant submits that the present disclosure will contribute in country economy, which is one of the purposes to enact the Patents Act. 1970. The product in accordance with present invention will be in great demand in country and worldwide due to novel technical features of a present invention is a technical advancement in the biodegradable polymer. The technology in accordance with present disclosure will provide product cheaper, saving in time of total process of manufacturing. The saving in production time will improve the productivity, and cost cutting of the product. which will directly contribute to economy of the country.

The product will contribute new concept in the biodegradable polymer wherein patented process/product will be used. The present disclosure will replace the whole concept of biodegradable polymers being used in this area from decades. The product is developed in the national interest and will contribute to country economy.

The economy significance details requirement may be called during the examination. Only after filing of this Patent application. the applicant can work publically related to present disclosure product/process/method. The applicant will disclose all the details related to the economic significance contribution after the protection of invention.

1. A biodegradable polymer being a reaction product of:
at least one aliphatic diol in an amount in the range of 30 mass % to 40 mass % with respect to the total mass of the polymer;
at least one ester of aliphatic diacid in an amount in the range of 10 mass % to 35 mass % with respect to the total mass of the polymer;
one of a compound selected from a tartrate and a threitol in an amount in the range of 5 mass % to 25 mass % with respect to the total mass of the polymer;
at least one catalyst in an amount in the range of 0.5 mass % to 1.5 mass % with respect to the total mass of the polymer; and
at least one ester of aromatic diacid in an amount in the range of 25 mass % to 35 mass % with respect to the total mass of the polymer.

2. The biodegradable polymer as claimed in claim 1 comprises at least one branching agent in an amount in the range of 0 mass % to 0.2 mass % with respect to the total mass of the polymer.

3. The biodegradable polymer as claimed in claim 2, wherein said branching agent is at least one selected from the group consisting of mucic acid, glycerol, pentaerythritol, 1,1,1-trimethylolethane, 1,2,4-butanetriol, trimellitic acid, pyromellitic acid, trimethylolethane, polyethertriol, trimesic acid, pyromellitic acid and hydroxyisophthalic acid.

4. The biodegradable polymer as claimed in claim 1, wherein said aliphatic diol is at least one selected from the group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethyl-1,3-hexanediol, 2,2-dimethyl-1,3-propanediol, 2-ethyl-2-butyl-1,3-propanediol, 2-ethyl-2-isobutyl-1,3-propanediol and 2,2,4-trimethyl-1,6-hexanediol, 1,2-cyclopentanediol, 1,2-cyclohexanediol, 1,4-cyclohexanediol, 1,2-cyclohexanedimethanol, 1,3-cyclohexanedimethanol, 1,4-cyclohexanedimethanol and derivatives thereof.

5. The biodegradable polymer as claimed in claim 1, wherein said aliphatic diacid is at least one selected from the group consisting of oxalic acid, malonic acid, succinic acid, glutaric acid, adipic acid, pimelic acid, suberic acid, azelaic acid, sebacic acid, undecanedioic acid, dodecanedioic acid, brassylic acid, tetradecanedioic acid, 1,3-cyclopentanedicarboxylic acid, 1,4-cyclohexanedicarboxylic acid, 1,3-cyclohexanedicarboxylic acid, diglycolic acid, itaconic acid, maleic acid, fumaric acid, and maleic anhydride.

6. The biodegradable polymer as claimed in claim 1, wherein said ester of aliphatic diacid is selected from the group consisting of dimethyl adipate, dimethyl succinate, dimethyl malonate, dimethyl glutarate. dimethyl suberate, and dimethyl sebacate.

7. The biodegradable polymer as claimed in claim 1, wherein said tartrate is dimethyl 2,3- [symbol] -isopropylidene tartrate, and said threitol is 2,3- [symbol] -isopropylidene threitol.

8. The biodegradable polymer as claimed in claim 1, wherein said catalyst is at least one selected from the group consisting of titanium, tetrabutyl titanate, tetrapropyl titanate, calcium acetate, antimony trioxide, monobutyl tin oxide, zinc acetate, and antimony acetate.

9. The biodegradable polymer as claimed in claim 1, wherein said aromatic diacid is at least one selected from the group consisting of terephthalic acid, phthalic acid isophthalic acid, 4-methylphthalic acid, naphthalene dicarboxylic acid, and derivatives thereof.

10. The biodegradable polymer as claimed in claim 1, wherein said ester of aromatic diacid is selected from dimethyl terephthalate, phthalic anhydride, dimethyl isophthalate, 4-methylphthalic anhydride, and dimethyl phthalate.

11. The biodegradable polymer as claimed in claim 1, is characterized by having:
number average molecular weight (Mn) in the range of 5×10³ g/mol to 50×10³ g/mol;
weight average molecular weight (Mw) in the range of 10×10³ g/mol to 120×10³ g/mol;
polydispersity index (PDI) in the range of 1 to 3;
melting temperature (Tm) in the range of 70° C. to 140° C.;
glass transition temperature (Tg) in the range of −50° C. to −20° C.;
crystallization temperature (Tc) in the range of 65° C. to 115° C.; and
enthalpy of the reaction (ΔH) in the range of 3 J/g to 8 J/g.

12. A process for preparing a biodegradable polymer as claimed in claim 1, said process comprising the following steps:
creating an inert atmosphere in a reactor;
mixing predetermined amounts of at least one aliphatic diol, at least one ester of aliphatic diacid, one of a compound selected from a tartrate and a threitol, at least one catalyst and optionally at least one branching agent under said inert atmosphere in said reactor to obtain a slurry;
heating said slurry at a first predetermined temperature for a first predetermined time period followed by addition of a predetermined amount of at least one ester of aromatic diacid to obtain a homogeneous mixture; and
heating said homogeneous mixture at a second predetermined temperature for a second predetermined time period at a predetermined pressure in said inert atmosphere to obtain the biodegradable polymer.

13. The process as claimed in claim 12, wherein said inert atmosphere is selected from nitrogen and argon.

14. The process as claimed in claim 12, wherein said aliphatic diol is at least one selected from the group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethyl-1,3-hexanediol, 2,2-dimethyl-1,3-propanediol, 2-ethyl-2-butyl-1,3-propanediol, 2-ethyl-2-isobutyl-1,3-propanediol and 2,2,4-trimethyl-1,6-hexanediol, 1,2-cyclopentanediol, 1,2-cyclohexanediol, 1,4-cyclohexanediol, 1,2-cyclohexanedimethanol, 1,3-cyclohexanedimethanol, 1,4-cyclohexanedimethanol and derivatives thereof, preferably 1,4-butanediol.

15. (canceled)

16. The process as claimed in claim 12, wherein
said ester of aliphatic diacid is selected from the group consisting of dimethyl adipate, dimethyl succinate, dimethyl malonate, dimethyl glutarate. dimethyl suberate, and dimethyl, preferably dimethyl adipate; and
said ester of aromatic diacid is selected from dimethyl terephthalate, phthalic anhydride, dimethyl isophthalate, 4-methylphthalic anhydride, and dimethyl phthalate, preferably dimethyl terephthalate.

17-18. (canceled)

19. The process as claimed in claim 12, wherein said tartrate is dimethyl 2,3- [symbol] -isopropylidene tartrate, and said threitol is 2,3- [symbol] -isopropylidene threitol.

20. The process as claimed in claim 12, wherein said catalyst is at least one selected from the group consisting of titanium, tetrabutyl titanate, tetrapropyl titanate, calcium acetate, antimony trioxide, monobutyl tin oxide, zinc acetate, and antimony acetate, preferably titanium.

21. (canceled)

22. The process as claimed in claim 12, wherein said branching agent is at least one selected from the group consisting of mucic acid, glycerol, pentaerythritol, 1,1,1-trimethylolethane, 1,2,4-butanetriol, trimellitic acid, pyromellitic acid, trimethylolethane, polyethertriol, trimesic acid, pyromellitic acid and hydroxyisophthalic acid.

23-25. (canceled)

26. The process as claimed in claim 12 wherein:
said first predetermined temperature is in the range 160° C. to 180° C.;
said first predetermined time period is in the range of 2 hours to 4 hours;
said predetermined pressure is in the range 1 torr to 5 torr;
said second predetermined temperature is in the range 190° C. to 250°0 C. and
said second predetermine time period is in the range4 hours to six hours.

27-28. (cancelled)

29. The process as claimed in claim 12, wherein a mass ratio of said aliphatic diol to said aromatic diacid is in the range 1:0.5 to 1:2, preferably in the range of 1:0.9 to 1:1.8.

30-31. (canceled)
